(19) United States
(12) Patent Application Publication
(10) Pub. No.: US 2012/0043444 A1
(43) Pub. Date: Feb. 23, 2012

(54) HANGER DEVICE

(76) Inventor: Michael Kingery, Flora, IN (US)

(21) Appl. No.: 13/214,736

(22) Filed: Aug. 22, 2011

Related U.S. Application Data
(60) Provisional application No. 61/375,905, filed on Aug. 23, 2010.

(51) Int. Cl. F16B 45/00; B23P 11/00; F16M 13/00

(52) U.S. Cl. 248/295.11; 248/304; 29/428

(57) ABSTRACT

Devices and methods for hanger devices are provided. In an exemplary embodiment of the present disclosure, an attachment device is provided. The attachment device comprises a hanger receiving portion, the hanger receiving portion having at least a first surface and a second surface and a receiver located between the first surface and the second surface and extending into the hanger receiving portion, and a set screw opening extending from the first surface to the receiver, the second surface adapted to releasably attach the hanger receiving portion to a mounting object, and a hanger including a first portion and a hook portion, the first portion sized to be removably inserted into the receiver, the hook portion having a shape to hold a decorative object.

### CROSS REFERENCE TO RELATED APPLICATIONS

This application claims priority to U.S. Provisional Patent Application No. 61/375,905, filed Aug. 23, 2010, the entire disclosure of which is incorporated by reference.

### BACKGROUND OF THE DISCLOSURE

Many homeowners like to decorate their doors with wreaths or other decorations throughout the year, reflecting the current season or holiday. Traditional ways of mounting wreaths, especially over-the-door hangers, can scratch the finish of the door or door frame or make excessive noise when the wind blows or by the act of opening and closing the door. Additionally this method of hanging wreaths does not take into account other door fixtures, such as doorknockers or peep holes. Depending on where these items are located on the door, the over-the-door hanger could potentially cover them and make them inaccessible.

### SUMMARY

The present disclosure provides devices and methods for hanger devices. In an exemplary embodiment of the present disclosure, an attachment device is provided. The attachment device comprises a hanger receiving portion, the hanger receiving portion having at least a first surface and a second surface and a receiver located between the first surface and the second surface and extending into the hanger receiving portion, and a set screw opening extending from the first surface to the receiver, the second surface adapted to releasably attach the hanger receiving portion to a mounting object, and a hanger including a first portion and a hook portion, the first portion sized to be removably inserted into the receiver, the hook portion having a shape to hold a decorative object.

In another exemplary embodiment of the present disclosure, a method of attaching a decorative object to an attachment device is provided. The method comprises providing a hanger receiving portion, the hanger receiving portion having at least a first surface and a second surface and a receiver extending into the hanger receiving portion and located between the first surface and the second surface, and a set screw opening extending from the first surface to the receiver, the second surface adapted to releasably attach the hanger receiving portion to a mounting object, providing a hanger including a first portion and a hook portion, the first portion sized to removably insert into the receiver, the hook portion having a shape to hold a decorative object, attaching the hanger receiving portion to the mounting object, inserting the first portion of the hanger into the receiver, inserting a set screw into the set screw opening, the set screw contacting the first portion of the hanger, and attaching the decorative object to the hook portion of the hanger.

Additional features and advantages of the present disclosure will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a front view of an exemplary door hanger holding a decorative object according to an embodiment of the present disclosure.

FIG. 2 is a side view of the exemplary door hanger of FIG. 1.

FIG. 3 is a front view of the exemplary door hanger of FIG. 1, affixed to a door.

FIG. 4 is a top perspective view of an exemplary door hanger, with the hanger portion and the hanger receiving portion separated according to an embodiment of the present disclosure.

FIG. 5 is a cross-sectional view taken along line 5-5 of FIG. 4, showing the position of a set screw according to an embodiment of the present disclosure.

FIG. 6 is a cross-sectional view taken along line 5-5 of FIG. 4, showing an alternate position of a set screw according to an embodiment of the present disclosure.

FIG. 7 is a front perspective view of a door hanger in an alternate embodiment according to an embodiment of the present disclosure.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes a specific embodiment of door hanger 100, it should be understood that the concepts presented herein may be used in other various configurations consistent with this disclosure.

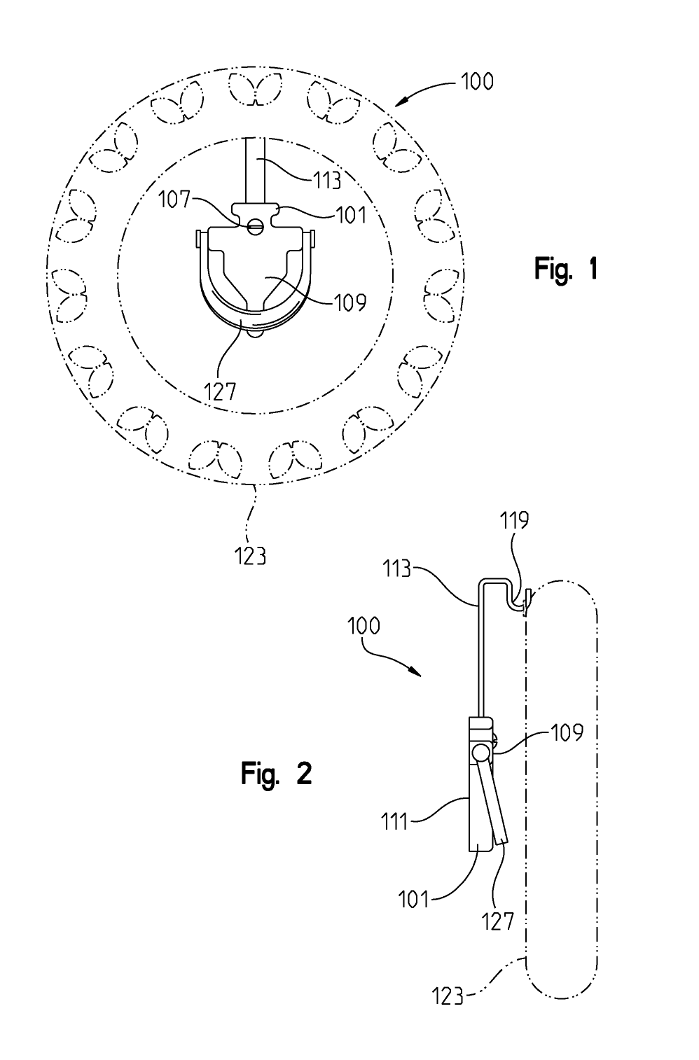

Shown with reference to FIG. 1, a door hanger 100 includes a hanger receiving portion 101 and a hanger 113. In the embodiment shown in FIG. 1, the hanger 113 may form a hook or other shape to releasably retain a decorative object 123. The decorative object 123 may include, but is not limited to, a wreath, a sign, garland, a bow, or other object. In the embodiment, the hanger 113 is releasably attached to the hanger receiving portion 101.

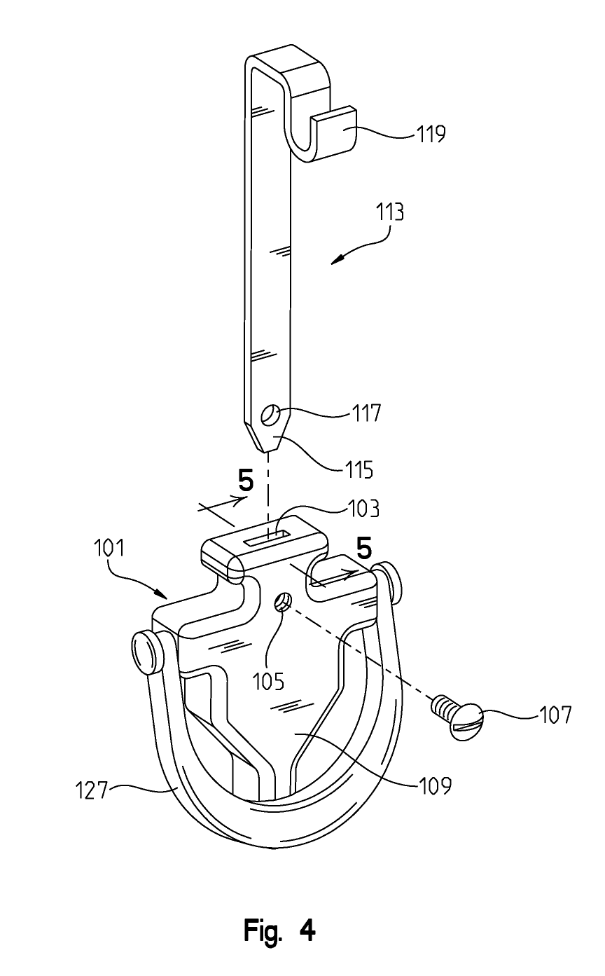

FIG. 4 is a top perspective view of an exemplary door hanger 100, with the hanger 113 portion and the hanger receiving portion 101 separated according to an embodiment of the present disclosure. Shown in FIG. 4, the hanger receiving portion 101 includes a receiver 103 to receive the tapered portion 115 of the hanger 113. The hanger receiving portion 101 includes a first surface 109 that faces away from the mounting object 121, and a second surface 111 that faces the mounting object 121. Shown in FIG. 1, the first surface 109 of the hanger receiving portion 101 may, in an embodiment, have a decorative appearance. The receiver 103 is positioned so that the tapered portion 115 of the hanger 113 is inserted in a direction substantially parallel to the second surface 111 of the hanger receiving portion 101.

The first surface 109 of the hanger receiving portion 101 may also contain additional features. For example, the hanger receiving portion 101 may include a peephole to allow a user on one side of the door or other mounting object 121 to see to the other side of the door. The peephole may extend through an opening (not shown) in the hanger receiving portion 101 and through an opening (not shown) in the mounting object 121. The hanger receiving portion 101 may also, in an embodiment, include a door knocker 127 that a user may use to strike a portion of the hanger receiving portion 101 to create a sound. The hanger receiving portion 101 may, in an embodiment, also include a fixed or removable placard or other device to display, for example and without limitation, a portion or an entire street address, a name, or other characters. The hanger receiving portion 101 may also include an emblem or other decorative or symbolic object.

FIG. 7 shows a front perspective view of a door hanger 100 in an alternate embodiment according to an embodiment of the present disclosure. The first surface 601 of the alternate embodiment may be different than the first surface shown in FIGS. 1-4, but may include the set screw opening 105 and receiver 103 to engage with a hanger 113. In a further alternate embodiment, the first surface 601 of the hanger receiving portion 101 is a decorative object. The decorative first surface 601 includes a set screw opening 105, and the hanger receiving portion 101 also includes a receiver 103. In an embodiment, the decorative first surface 601 may be partially or fully detachable from the hanger receiving portion 101 so that the first surface 109 may be changed if necessary or desired. The decorative first surface 601, in the embodiment, may be releasably attached to the hanger receiving portion 101 by screws, tabs, or other similar devices to releasably secure the decorative first surface 601 to the hanger receiving portion 101. In the embodiment, the receiver 103 and the set screw opening 105 are associated with the hanger receiving portion 101 so that the decorative first surface 601 includes an opening to the receiver 103 and set screw opening 105, or is designed so that it does not cover or substantially cover the receiver 103 and set screw opening 105.

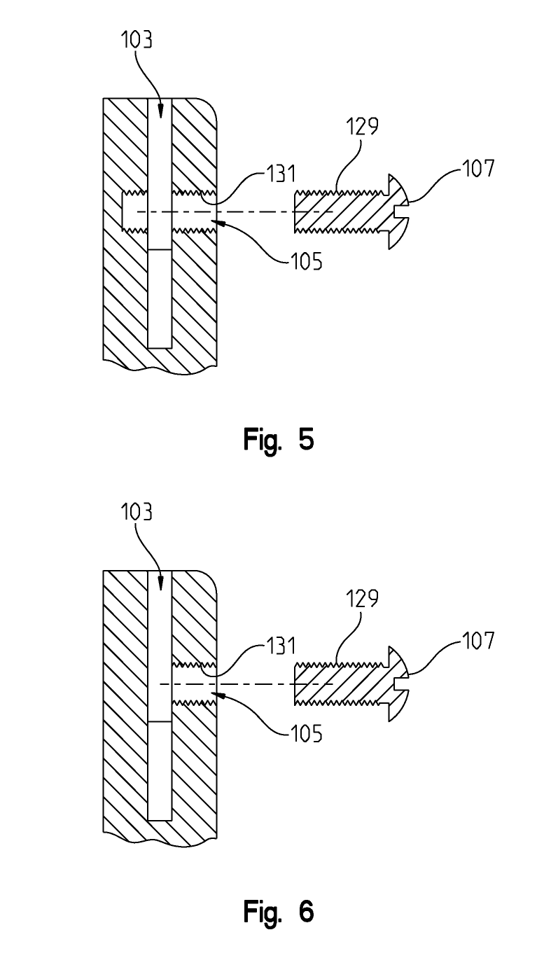

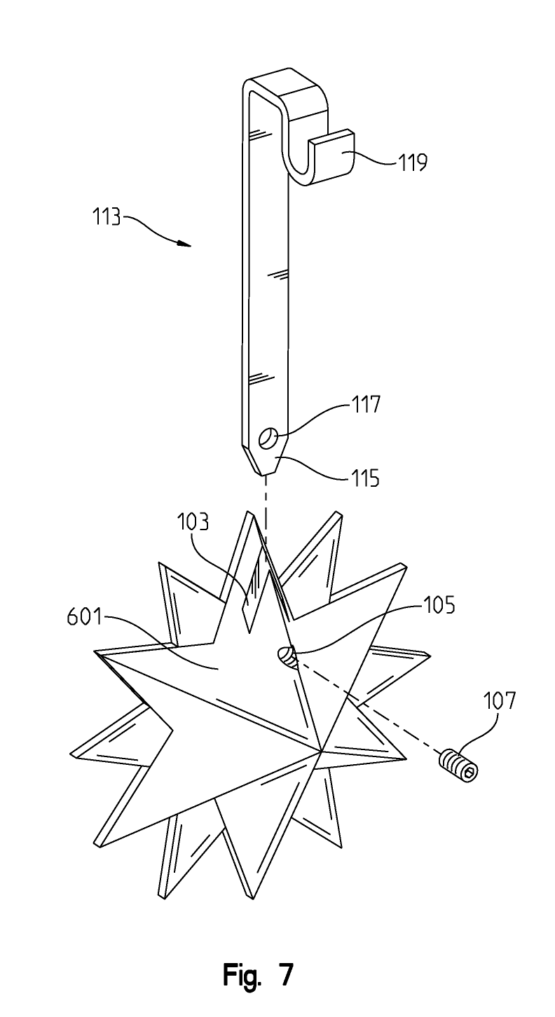

The receiver 103 extends into the hanger receiving portion 101. The set screw opening 105 is an opening in the first surface 109 of the hanger receiving portion 101 that intersects with the receiver 103, so that a set screw 107 or other object may be inserted into the set screw opening 105 and into the receiver 103. While the set screw opening 105 is shown as perpendicular or substantially perpendicular to the receiver 103, the set screw opening 105 may be positioned at any angle with respect to the receiver 103. In an embodiment, threads 129 are disposed along the inner walls of the set screw opening 105, shown in FIGS. 5 and 6. The threads 129 engage with complimentary threads 131 on the outer surface of the set screw 107 to retain the set screw 107 in the set screw opening 105. The position of the set screw 107 within the hanger receiving portion 101 in an embodiment is shown in FIG. 6. When the hanger 113 is installed within the receiver 103, the inner walls of the receiver 103 prevent substantial movement of the hanger 113 from side-to-side, shown as lateral movement with respect to FIGS. 1-4, and also prevent substantial movement of the hanger 113 in the direction toward and away from the mounting object 121.

In an embodiment, and as shown in FIG. 5, the set screw opening 105 extends through one surface of the receiver 103 and into the opposite surface. The set screw 107, in the embodiment, extends through the set screw opening 105 and into the receiver 103, through the opening of the hanger 113, and into the opening in the opposite surface of the receiver 103. This configuration may help to prevent accidental deinstallation of the hanger 113, as the set screw 107 is in communication with two sides of the receiver 103.

The set screw 107 is a metal or plastic material, and may be the same material as the hanger 113, or may be a different material. The set screw 107 may have substantially the same color as the hanger receiving portion 101, or may have a different color. The set screw 107 includes an engaging portion and a head. In an embodiment, the head is decorative, and matches the decor of the front surface of the hanger receiving portion 101. In another embodiment, a cap or other device fits over the head to hide the set screw 107 from view. The engaging portion, in an embodiment, includes threads that are complimentary to the threads disposed in the set screw opening 105.

FIG. 4 includes a side perspective view of a hanger 113 according to an embodiment of the present disclosure. The hanger 113, in the embodiment, includes a tapered portion 115 and a hook portion 119. In an embodiment, the hook portion 119 is “S” shaped created by a first bend, a second bend, and a third bend. The hook portion 119 may, in an embodiment, be used to hold a wreath or other decorative object 123. In another embodiment, the hook portion 119 is another form of attachment for a decorative object 123. For example, the hook portion 119 may include a ring or other suitable fastener to grip or otherwise hold a decorative object 123.

The hanger 113 may be a metal or plastic material, or a combination of both metal material and plastic material. For example, the hanger 113 may be a metal material coated with a plastic material, or encased in a plastic material. In an embodiment, the hanger 113 is brass. In another embodiment, the hanger 113 is stainless steel, bronze, or another metal or metal alloy. The hanger 113 may be finished in any way, or in a way similar to the finish of the hanger receiving portion 101. For example, and without limitation, the hanger 113 may have a polished, brushed, antique, or oil-rubbed finish. The plastic material may include rubber, or any other compound to reduce scratching or marring of the surface of the object and/or the decorative object 123.

In an embodiment, the hanger 113 is between approximately 8 and 12 inches long, one inch wide, and 1/16 inches thick. The width and thickness may vary along the hanger 113. The hanger 113 may be sized differently depending on the function. For example, the hanger 113 may be one inch wide near the tapered portion 115, so that the portion of the hanger 113 adjacent to the tapered portion 115 fits within the receiver 103, but may flare or narrow to another width at another portion. The thickness of the hanger 113 at or near the tapered portion 115 may be sized so that the hanger 113 fits within the receiver 103, but may be another thickness at the hook portion 119, to allow for heavier or lighter decorative objects 123.

The attachment portion of the hanger 113 includes an opening 117 through the hanger 113. The opening 117 may, in an embodiment, include threads disposed within the opening 117 to engage the set screw 107. In another embodiment, the opening 117 does not have threads disposed within. In another embodiment, the attachment portion does not include an opening 117, and the set screw 107 presses against the attachment portion, preventing movement of the hanger 113 within the receiver 103.

In an embodiment, the length of the attachment portion is adjustable. The attachment portion may be adjustable to move the position of the hook portion 119 with respect to the hanger receiving portion 101. This may be desirable, for example, for centering a wreath or other decorative object 123 around the hanger receiving portion 101, or adjusting the height of the decorative object 123 on the door or other mounting object 121. The receiver 103 may be sized so that the attachment portion may be moved within the receiver 103, and then releasably locked using the set screw 107. In another embodiment, the attachment portion includes a plurality of openings 117, so that the height of the attachment portion within the receiver 103 may be changed by selecting an opening 117 for the set screw 107 to engage. In another embodiment, the attachment portion contains a plurality of openings 117 and a plurality of marks, so that portions of the attachment portion may be detached, sizing the attachment portion so that the hanger 113 holds the decorative object 123 at a selected height.

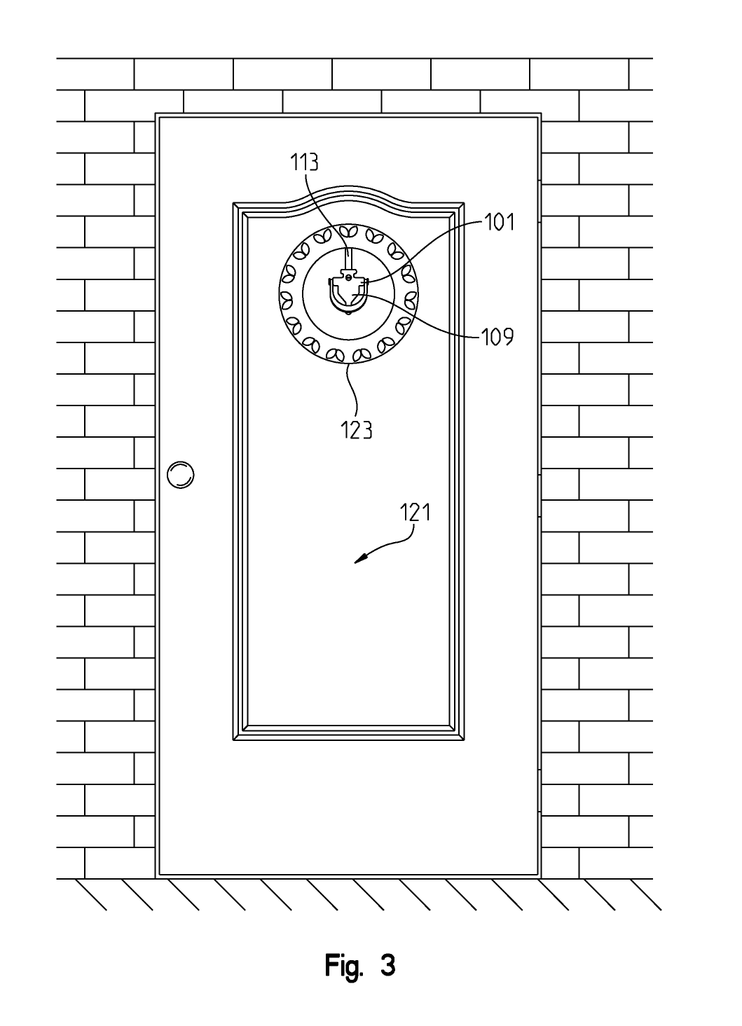

In the embodiment shown in FIG. 3, the hanger receiving portion 101 is attached to a mounting object 121, such as a door. The hanger receiving portion 101 may, in other embodiments, be attached to other mounting objects 121. The hanger receiving portion 101 may be attached to the mounting object 121 by, for example and without limitation, one or more screws or nails that extend through one or more holes in the hanger receiving portion 101 and extend into or through the mounting object 121. If the screws or nails extend through the mounting object 121, the screws or nails may be in communication with one or more structures, such as a comparable nut, to retain the one or more screws or nails to the mounting object 121. In another embodiment, the hanger receiving portion 101 may include one or more screws or nails that are attached to the hanger receiving portion 101. For example, one or more nails may be welded to the hanger receiving portion 101, or one or the hanger receiving portion 101 may be cast or machined with one or more nails extending from the surface facing the mounting object 121. In another embodiment, the surface of the hanger receiving portion 101 that faces the mounting object 121 may be coated or in communication with an adhesive, or an material, such as foam or other suitable material, with an adhesive on both sides may be placed between the surface of the hanger receiving portion 101 that faces the mounting object 121 and the surface of the mounting object 121, to affix the hanger receiving portion 101 to the mounting object 121. In an embodiment, the hanger receiving portion 101 is releasably attached to the mounting object 121. In another embodiment, the hanger receiving portion 101 is not releasably attached to the mounting object 121.

In operation, the hanger receiving portion 101 is attached to the mounting object 121. The hanger receiving portion 101 may be attached to the mounting object 121 with an adhesive, screws, or other suitable mounting materials. The user places the tapered portion 115 of the hanger 113 in the receiver 103, and inserts the set screw 107 into the set screw opening 105 on the first surface 109. The set screw 107 travels through the first surface 109 and into the receiver 103, and then through the set screw opening 105 of the hanger 113. In an embodiment, the hanger 113 does not include a set screw opening 105, and the set screw 107 is pressed against the hanger 113 within the receiver 103, preventing removal of the hanger 113. The set screw 107 prevents the hanger 113 from being removed from the hanger receiving portion 101. To reverse the installation, the set screw 107 is removed from the set screw opening 105 of the hanger 113, and the tapered portion 115 of the hanger 113 and/or the attachment portion of the hanger 113 is removed from the receiver 103. The set screw 107 may not be completely removed from the hanger receiving portion 101 if it does not substantially interfere with the removal of the hanger 113.

In an embodiment, the user selects the height of the hanger 113 by changing the length of the adjustment portion of the hanger 113, or by changing the depth of the adjustment portion within the receiver 103 of the hanger receiving portion 101.

While this disclosure has been described as having exemplary designs, the present disclosure can be further modified within the spirit and scope of this disclosure. This application is therefore intended to cover any variations, uses or adaptations of the disclosure using its general principles. Further, this application is intended to cover such departures from the present disclosure as come within known or customary practice in the art to which this disclosure pertains and which fall within the limits of the appended claims.

1. An attachment device, comprising:
a hanger receiving portion, the hanger receiving portion having at least a first surface and a second surface and a receiver located between the first surface and the second surface and extending into the hanger receiving portion, and a set screw opening extending from the first surface to the receiver, the second surface adapted to releasably attach the hanger receiving portion to a mounting object;
a hanger including a first portion and a hook portion, the first portion sized to be removably inserted into the receiver, the hook portion having a shape to hold a decorative object.

2. The attachment device of claim 1, wherein the receiver is located along the top of the hanger receiving portion when the hanger receiving portion is installed on the mounting object.

3. The attachment device of claim 1, wherein the receiver prevents the hanger from substantial lateral movement when the hanger is installed within the receiver.

4. The attachment device of claim 1, wherein the set screw opening is substantially perpendicular to the receiver, and the set screw opening intersects the receiver.

5. The attachment device of claim 1, further including threads disposed on the inner surface of the set screw opening.

6. The attachment device of claim 5, further comprising a set screw, the set screw including threads disposed on the outer surface, wherein the threads are complimentary to the threads disposed on the inner surface of the set screw opening.

7. The attachment device of claim 1, wherein the first surface has a decorative appearance.

8. The attachment device of claim 1, wherein the first surface is removable from the hanger receiving portion.

9. The attachment device of claim 1, wherein the hanger includes an adjustment portion, wherein a portion of the adjustment portion is selectively removed to adjust the height of the hanger.

10. An attachment device, comprising:
a hanger receiving portion, the hanger receiving portion having at least a first surface and a second surface and a receiver positioned between the first surface and the second surface, and a set screw opening extending from the first surface to the receiver, wherein the set screw opening is substantially perpendicular to the receiver and intersects the receiver and includes set screw opening threads disposed on the inner surface, the second surface adapted to releasably attach the hanger receiving portion to a mounting object;
a set screw, the set screw including threads disposed on the outer surface, wherein the threads are complimentary to the threads disposed on the inner surface of the set screw opening; and
a hanger including a tapered portion and a hook portion, the tapered portion sized to removably insert into the receiver and including an opening through the tapered portion, wherein the opening is at least as large as the diameter of the set screw, the hook portion sized to hold a decorative object.

11. The attachment device of claim 10, wherein the receiver prevents the hanger from substantial lateral movement when the hanger is installed within the receiver.

12. The attachment device of claim 10, wherein the first surface has a decorative appearance.

13. The attachment device of claim 10, wherein the first surface is removable from the hanger receiving portion.

14. The attachment device of claim 10, wherein the hanger includes an adjustment portion, wherein a portion of the adjustment portion is selectively removed to adjust the height of the hanger.

15. A method of attaching a decorative object to an attachment device, comprising:
providing a hanger receiving portion, the hanger receiving portion having at least a first surface and a second surface and a receiver extending into the hanger receiving portion and located between the first surface and the second surface, and a set screw opening extending from the first surface to the receiver, the second surface adapted to releasably attach the hanger receiving portion to a mounting object;
providing a hanger including a first portion and a hook portion, the first portion sized to removably insert into the receiver, the hook portion having a shape to hold a decorative object;
attaching the hanger receiving portion to the mounting object;
inserting the first portion of the hanger into the receiver;
inserting a set screw into the set screw opening, the set screw contacting the first portion of the hanger; and
attaching the decorative object to the hook portion of the hanger.
